(19) United States
(12) Patent Application Publication
(10) Pub. No.: US 2002/0113775 A1
(43) Pub. Date: Aug. 22, 2002

(54) Ergonomic hand-held computer input device

(75) Inventor: Robert Spencer, Nashville, TN (US)

Correspondence Address: Aldo J. Test, FLEHR HOHBACH TEST, ALBRITTON & HERBERT LLP, Four Embarcadero Center, Suite 3400, San Francisco, CA, 94111-4187, US

(73) Assignee: 3Wize, Inc.

(21) Appl. No.: 09/791,971

(22) Filed: Feb. 22, 2001

(51) Int. Cl. G09G 5/08

(52) U.S. Cl. 345/164

(57) ABSTRACT

A hand-held computer input device which can be comfortably held by the hand of a user while the thumb and fingers are associated with the track ball and keys. The overall configuration of the device is an elongated handle which can be grasped in the palm of the hand with the thumb operating a track ball and the fingers operating control switches carried by the device.

### BRIEF DESCRIPTION OF THE INVENTION

This invention relates generally to a computer input device, and more particularly to a hand-held ergonomic computer input device.

### BACKGROUND OF THE INVENTION

Hand-operated computer devices take many forms including keys, levers, touch-screens, track balls and mice. The most commonly used hand-operated device for controlling cursor movement on computer screens is the mouse. The mouse includes a housing which houses a rotatable track ball which extends outwardly from the underside of the mouse and frictionally engages a support surface such as a mouse pad. A mouse also includes control keys on its upper surface which are operated by the fingers applying various other commands to the computer. The track ball is rotated about any axis, an encoder within the housing detects motion of the track ball, generates and conveys the cursor signals to the computer.

Studies have shown that, because the mouse sits away from the keyboard, that the user must reach out to use it. This puts substantial stress on the neck, arms and shoulders of the users, when using a mouse.

Another type of input device is hand-held and includes a track ball which extends above the surface of the device and is manipulated by the fingers. However, such hand-held devices are not ergonomically designed so that they can be comfortably held in the palm of the hand in a position where the track ball and keys can be easily manipulated by the fingers.

### OBJECTS AND SUMMARY OF THE INVENTION

It is a general object of the present invention to provide a hand-held ergonomic computer input device.

It is a further object of the present invention to provide a hand-held computer input device in which the user is free to move around away from the computer and/or desk.

There is provided an input device which includes an elongated handle shaped to fit comfortably in the palm of the hand. The handle is bent forward with a track ball mounted for rotation on the rear of the device for engagement by the thumb. The front of the device carries control switches which are adapted to be engaged by the first two fingers of the hand. In section, the shape is oblong so that the side can be placed in the palm of the hand with the fingers curling over the front, and the thumb adjacent the back.

### DESCRIPTION OF THE DRAWINGS

The foregoing and other objects of the invention will be more clearly understood from the following description when read in connection with the accompanying drawings in which:

FIG. 1 illustrates the device held by the left hand of a user, with the first two fingers engaging the control switches, and the thumb engaging the track ball.

FIG. 2 is a side elevational view of the input device of FIG. 1.

FIG. 3 is a front elevational view of the device of FIG. 1.

FIG. 4 is a rear elevational view of the device of FIG. 1.

FIG. 5 is an enlarged top plan view of the device of FIG. 1 illustrating a replaceable ball feature.

FIG. 6 shows a second embodiment of the hand-held ergonomic computer input device.

### DESCRIPTION OF THE INVENTION

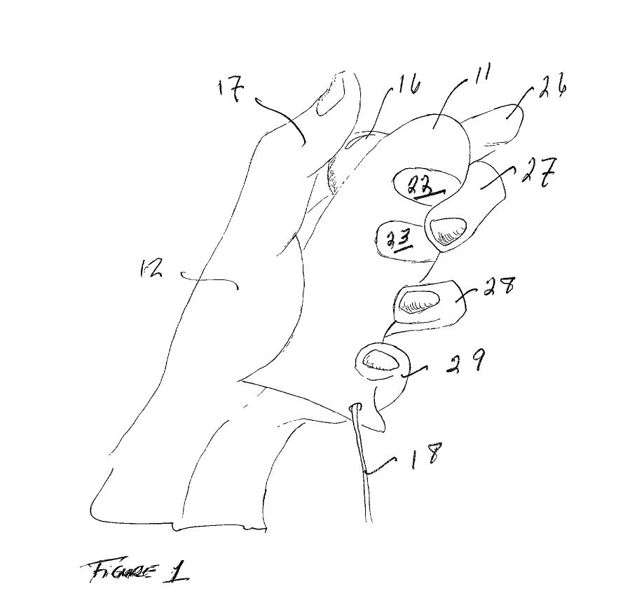

Referring to the Figures, and particularly to FIG. 1, the device 11 is illustrated as being operated in the left hand 12 of the user although, as will be apparent, it can be operated by the right hand because of its symmetrical shape. Referring to all of the figures, the device is in the form of an elongated handle with a rounded back surface 13 and a rounded front surface 14 which is inclined forwardly. The back surface supports a track ball 16 which is rotated by the thumb 17 of the user. As is well known, the track ball can be rotated about any axis and an encoder (not shown) in the handle housing detects the motion of the track ball and generates signals which are conveyed to an associated computer via a cable 18. Alternatively, the signals may be transferred to the computer by infrared or RF signals, eliminating the requirement for a cable 17.

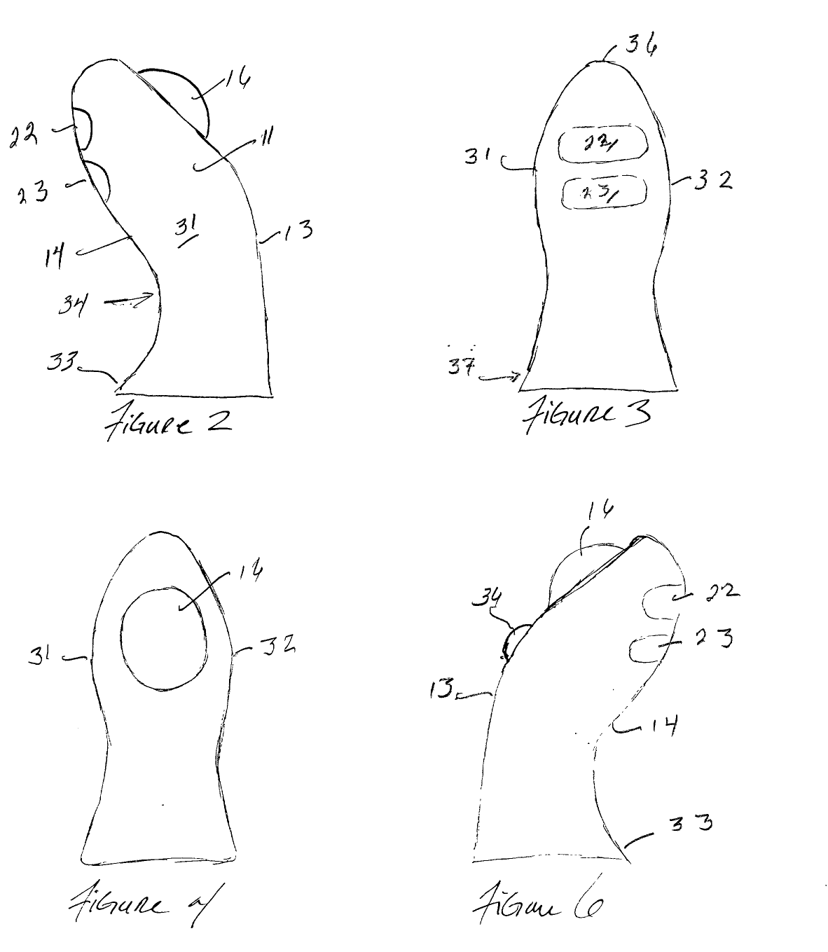

The front surface 14 includes switches 22 and 23 which are located for easy engagement by the first and second fingers of the hand 26 and 27. The other fingers 28 and 29 curl around the device and hold it. The device has curved sides 31 and 32 which merge with the rounded front and rear surfaces 13 and 14 to form a device whose side surface fits snugly in the palm of the hand. The other surface is easily grasped by the small fingers 28 and 29 for holding the device in an operating position. Preferably, the lower portion 33 of the device bends forwardly to form a region 34 of reduced size. This inhibits movement of the device upwardly or downwardly in the hand of the operator. FIGS. 3 and 4 illustrate the shape of the sides which are curved and merge at the top 36. They also curve outwardly at the bottom 37. In section, the shape of the device is oblong. The width and thickness of the device is selected so that it fits snugly in the palm of an average-sized palm with the first two fingers engaging the switches and the other two fingers engaging the small portion at the bottom. The back of the palm engages the back of the device with the thumb engaging the track ball. The hand-held input device can be held at any location and does not require movement of the head, shoulders and arms to reach to manipulate the device.

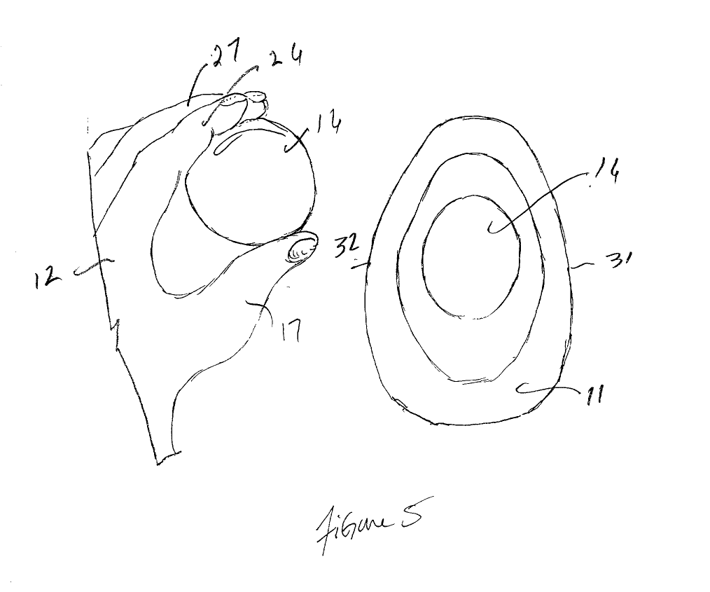

Referring to FIG. 5, the trackball 16 is shown removed for cleaning or replacement. In one embodiment of the invention, the track balls may be decorative or carry logos or other insignia used in advertising promotion, etc.

FIG. 6 shows an alternative embodiment which, in addition to a track ball, includes a page wheel 36 which is on the rear surface and can be manipulated by the thumb.

Thus, there has been provided an ergonomic hand-held input device which can be comfortably held in the hand in any location, and which can be easily manipulated by the fingers grasping and holding the device.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A hand-held computer input device comprising an elongated handle shaped to fit comfortably in the hand of a user, said handle including
a base, a rounded rear surface which extends upwardly and is inclined forwardly from said base,
a rotatable member carried on the rear surface for rotation by the thumb of a user,
a rounded front surface spaced from the rear surface which extends upwardly and inclined forwardly from said base,
spaced control switches carried on said front surface and for engagement by the first two fingers, and
curved side surfaces joined to said front and rear surfaces to form a handle, said handle shaped to be comfortably held in the palm of the hand of a user with the track ball positioned for operation by the thumb of the user, and the switches by the first fingers of the hand.

2. A device as in claim 1 in which said handle sides taper inwardly from the top and bottom to form a portion of reduced size adapted to be grasped by the little fingers of the hand, whereby to better position the device in the palm and inhibit movement of the handle in the hand.

3. A hand-held computer input device as in claim 1 in which the rotatable member is removable for cleaning or replacement.
